(19) United States
(12) Patent Application Publication
(10) Pub. No.: US 2020/0250678 A1
(43) Pub. Date: Aug. 6, 2020

(54) DETECTION APPARATUS, DETECTION METHOD, AND RECORDING MEDIUM

(71) Applicant: Hitachi, Ltd., Tokyo (JP)

(72) Inventors: Toyomitsu YONEDA, Tokyo (JP); Shunsuke KITAMURA, Tokyo (JP); Kenichi SHIMIZU, Tokyo (JP)

(73) Assignee: Hitachi, Ltd., Tokyo (JP)

(21) Appl. No.: 16/775,893

(22) Filed: Jan. 29, 2020

(30) Foreign Application Priority Data
Feb. 5, 2019 (JP) 2019-018804

(51) Int. Cl. G06Q 20/40; G06F 16/953; G06F 16/9537

(52) U.S. Cl. CPC G06Q 20/4016; G06F 16/9537; G06F 16/953

(57) ABSTRACT

A detection apparatus is configured to execute: a search process of accessing a site having a group of pages pertaining to transaction items using a search keyword pertaining to a legitimate transaction item, thereby searching the site for a given page including a character string that matches or relates to the search keyword; an acquisition process of acquiring, from the given page found by the search process, a first evaluation character string that indicates a given transaction item that is included in the given page, and a second evaluation character string that describes the given transaction item; an evaluation process of evaluating whether the given page is a page pertaining to an illegitimate transaction item on the basis of an evaluation keyword pertaining to an illegitimate transaction item, and the first and second evaluation character strings acquired; and an output process of outputting evaluation results obtained by the evaluation process.

### CLAIM OF PRIORITY

The present application claims priority from Japanese patent application JP 2019-18804 filed on Feb. 5, 2019, the content of which is hereby incorporated by reference into this application.

### BACKGROUND

The present invention relates to a detection apparatus, a detection method, and a detection program by which information is detected.

JP 2005-38402 A discloses a server system that, when probing for unauthorized use of image data that requires licensing, searches the internet for image data that matches or is similar to the image data subject to the probe, and that notifies the probe requester of results of the search. This server system has a search server and a management server, and is connected to a client terminal through a network. The management server records the image data inputted from the client terminal in a probe database as the image data being probed for each probe requester, and sets probe conditions for probing whether the image data has been used without authorization in a group of websites on a network. The search server calculates feature values of the image data recorded in the probe database and searches the group of websites for image data that matches or is similar to the image data being probed on the basis of the feature values and the search conditions, and the management server transmits the search results to the client terminal.

However, the server system disclosed in JP 2005-38402 accumulates image data in the probe database to increase accuracy. That is, an effort to keep adding image data to be recorded is required. Also, illegitimate content is uploaded to websites by changing the content or means of uploading, and thus, it would be difficult to adapt to changes in circumstance by a method in which image data is accumulated in a probe database.

### SUMMARY

An object of the present invention is to efficiently detect illegitimate transaction item candidates. A detection apparatus which is an aspect of the invention disclosed in the present application is a detection apparatus, comprising: a processor that is configured to execute a program; and a storage device that stores the program, wherein the processor is configured to execute: a search process of accessing a site having a group of pages pertaining to transaction items using a search keyword pertaining to a legitimate transaction item, thereby searching the site for a given page including a character string that matches or relates to the search keyword; an acquisition process of acquiring, from the given page found by the search process, a first evaluation character string that indicates a given transaction item that is included in the given page, and a second evaluation character string that describes the given transaction item; an evaluation process of evaluating whether the given page is a page pertaining to an illegitimate transaction item on the basis of an evaluation keyword pertaining to an illegitimate transaction item, and the first and second evaluation character strings acquired by the acquisition process; and an output process of outputting evaluation results obtained by the evaluation process. According to a representative embodiment of the present invention, it is possible to efficiently detect illegitimate transaction item candidates. Other objects, configurations, and effects than those described above are clarified by the following description of an embodiment.

### BRIEF DESCRIPTION OF THE DRAWINGS

FIG. 1 is a descriptive drawing showing an example of detection of illegitimate applications.

FIG. 2 is a block diagram for showing a hardware configuration example of a computer.

FIG. 3 is a block diagram showing a functional configuration example of the detection apparatus.

FIG. 4 is a descriptive drawing 1 showing examples of search keyword lists.

FIG. 5 is a descriptive drawing 2 showing examples of search keyword lists.

FIG. 6 is a descriptive drawing 3 showing examples of search keyword lists.

FIG. 7 is a descriptive drawing 1 showing examples of evaluation keyword lists.

FIG. 8 is a descriptive drawing 1 showing examples of evaluation keyword lists.

FIG. 9 is a descriptive drawing 1 showing examples of evaluation keyword lists.

FIG. 10 is a descriptive view showing an example of the scoring rules.

FIG. 11 is a descriptive drawing showing an example of an illegitimate application candidate detection list.

FIG. 12 is a descriptive view showing an example of a menu screen.

FIG. 13 is a descriptive view showing an example of the search condition setting screen.

FIG. 14 is a descriptive view showing an example of the country designation list setting screen.

FIG. 15 is a descriptive view showing an example of the search keyword setting screen.

FIG. 16 is a descriptive view showing an example of the search result count upper limit setting screen.

FIG. 17 is a descriptive view showing an example of the access sleep interval setting screen.

FIG. 18 is a flowchart showing an example of steps for the detection apparatus to perform the illegitimate application detection process.

FIG. 19 is a flow chart showing an example of detailed process steps of the illegitimate application candidate extraction process (step S1801) performed by the extraction unit.

FIG. 20 is a flow chart showing an example of detailed process steps of the list comparison process (step S1802) performed by the search refinement unit.

FIG. 21 is a flow chart showing an example of detailed process steps of the specification page data acquisition process (step S1803) performed by the acquisition unit.

FIG. 22 is a flow chart showing an example of detailed process steps of the illegitimate application candidate evaluation process (step S1804).

FIG. 23 is a flow chart showing an example of detailed process steps of the illegitimate application candidate detection list creation process (step S1805) performed by the creation unit.

### DETAILED DESCRIPTION OF THE EMBODIMENT

An embodiment of a detection apparatus 100, a detection method, and a detection program according to the present invention will be explained below with reference to the attached drawings. The detection apparatus 100, the detection method, and the detection program detect illegitimate transaction item candidates. “Transaction items” include articles and software. Smartphones and smartwatches are examples of articles and applications that are installed in smartphones and that control smartwatches are examples of software. In the embodiment below, an example is described in which unlicensed and illegitimate applications that have not received licensing from a provider (including developers) of legitimate applications are detected.

<Example of Detection of Illegitimate Applications>

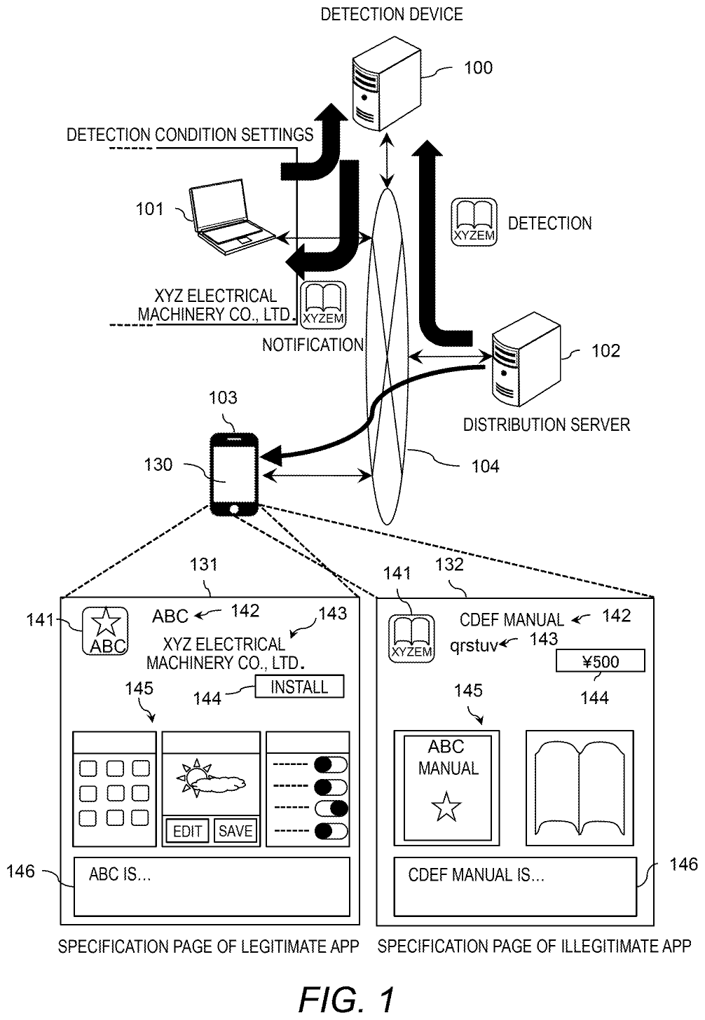

FIG. 1 is a descriptive drawing showing an example of detection of illegitimate applications. The detection apparatus 100, a user device 101, a distribution server 102, and an end user terminal 103 are connected to a network 104 such as the internet in a manner allowing communication therebetween. The detection apparatus 100 detects illegitimate transaction items as described above. The user device 101 sets search conditions for the detection apparatus 100 and receives notification of search results. The “user” is a person who uses the detection apparatus 100 by operating the user device 101. In this example, the user is an employee of XYZ Electrical Machinery Co., Ltd.

The distribution server 102 is a site having specification pages relating to the transaction items. The specification pages are web pages with information pertaining to the transaction items. In this example, the distribution server 102 is an application store that distributes applications for use on a smartphone. The specification pages are, for example, specification pages 131 and 132 of applications. The distribution server 102 has the function of returning a list of information in which URLs to corresponding specification pages (including IDs for the applications) are listed in the order of a score based on the degree of coincidence to a provided search keyword. The end user terminal 103 is a terminal used by the end user, and in this example is a smartphone. The “end user” is a user of the end user terminal 103.

The end user terminal 103 accesses the distribution server 102, downloads specification pages for applications, and displays the specification pages on a display screen 130. Here, a specification page 131 for a legitimate application and a specification page 132 for an illegitimate application are given as examples, and both specification pages 131 and 132 have the same layout. In this example, the illegitimate application has not received licensing from XYZ Electrical Machinery Co., Ltd., which provides the legitimate application, and is an electronic version of an operation manual for “CDEF”, which is a product of XYZ Electrical Machinery Co., Ltd.

The specification page 131 of the legitimate application and the specification page 132 of the illegitimate application both display an icon 141, an application name 142, a provider name 143, a download button 144, a thumbnail image 145, and a description 146. The icon 141 is a thumbnail image of a prescribed size indicating the application. The application name 142 is a character string indicating the name of the application. In this example, the application name 142 of the legitimate application is “ABC” and the application name 142 of the illegitimate application is “CDEF Manual”.

The provider name 143 is a character string indicating the name of the provider of the application. In this example, the provider name 143 of the legitimate application is “XYZ Electrical Machinery Co., Ltd.” and the provider name 143 of the illegitimate application is “qrstuv”. The download button 144 is a button that, by being pressed by the end user, enables downloading of the application. If the download button 144 says “Install”, then the application is free of charge. If the download button 144 states a price, then the application costs money.

In this example, the download button 144 of the legitimate application says “Install” whereas the download button 144 of the illegitimate application says “¥500”. Thus, the end user would not be charged for the legitimate application but would be charged for the illegitimate application. If such an illegitimate application were to become prevalent, then money that the legitimate provider should receive does not go to the provider, and even if the illegitimate application were free, if the quality of the illegitimate application is bad, this could damage the brand image of the legitimate provider. The thumbnail image 145 is an image introducing the application. The description 146 is a character string describing how to use the application.

<Computer Hardware Configuration Example>

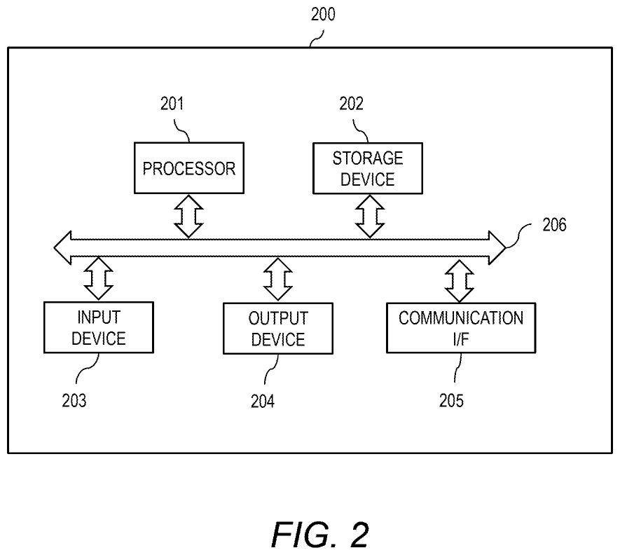

FIG. 2 is a block diagram for showing a hardware configuration example of a computer (examples of which include the detection apparatus 100, the user device 101, the distribution server 102, and the end user terminal 103). The computer 200 has a processor 201, a storage device 202, an input device 203, an output device 204, and a communication interface (communication I/F) 205. The processor 201, the storage device 202, the input device 203, the output device 204, and the communication I/F 205 are connected by a bus 206. The processor 201 controls the computer 200. The storage device 202 is the work area of the processor 201. Also, the storage device 202 is a non-transitory or transitory recording medium that stores various programs and data. Examples of such a storage device 202 include, for example, ROM (read only memory), RAM (random access memory), an HDD (hard disk drive), or a flash memory. The input device 203 is for inputting data. Examples of the input device 203 include a keyboard, a mouse, a touch panel, a numeric keypad, and a scanner. The output device 204 is for outputting data. Examples of the output device 204 include a display and a printer. The communication I/F 205 connects to the network and transmits/receives data.

<Functional Configuration Example of Detection Apparatus 100>

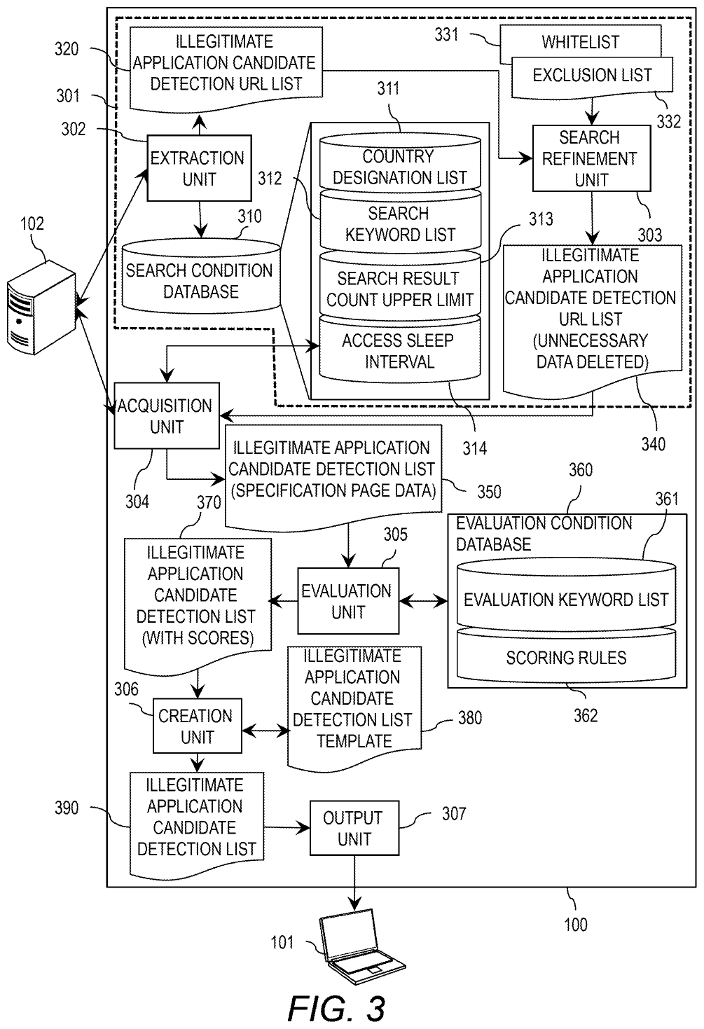

FIG. 3 is a block diagram showing a functional configuration example of the detection apparatus 100. The detection apparatus 100 has a search condition database 310, a whitelist 331, an exclusion list 332, an evaluation condition database 360, a search unit 301 (extraction unit 302 and search refinement unit 303), an acquisition unit 304, an evaluation unit 305, a creation unit 306, and an output unit 307. The search condition database 310 and the evaluation condition database 360 specifically are realized by the storage device 202 shown in FIG. 2, for example. The search unit 301 (evaluation unit 302 and search refinement unit 303), the acquisition unit, the evaluation unit, the creation unit, and the output unit are specifically realized by the processor 201 executing programs stored in the storage device 202 shown in FIG. 2, for example.

The search condition database 310 is a database that stores search conditions. The search condition database 310 is provided in the detection apparatus 100, but may be provided externally so as to be accessible by the detection apparatus 100. The search condition database 310 specifically stores a country designation list 311, a search keyword list 312, a search result count upper limit 313, and an access sleep interval 314, for example.

The country designation list 311 is a list of information of country codes that designate countries (or regions). As an example, the code for Japan is “JP”, the code for the United States is “US”, the code for the People's Republic of China is “CN”, and the code for Taiwan is “TW”. The distribution server 102 changes the group of applications that can be distributed in each country. The specification page of a given application indicates in the end user terminal 103 in a certain country that the application is downloadable, while not indicating that the application is downloadable in the end user terminal 103 in other countries, for example. The country designation list 311 is set in the detection apparatus 100 in advance or by the user operating the user device 101. The country code is selected from the country designation list 311 by the user operating the user device 101.

The search keyword list 312 is a list of information pertaining to search keywords. There is a search keyword list 312 for each type of search keyword. The search keyword is a keyword for searching a group of specification pages of applications stored by the distribution server 102.

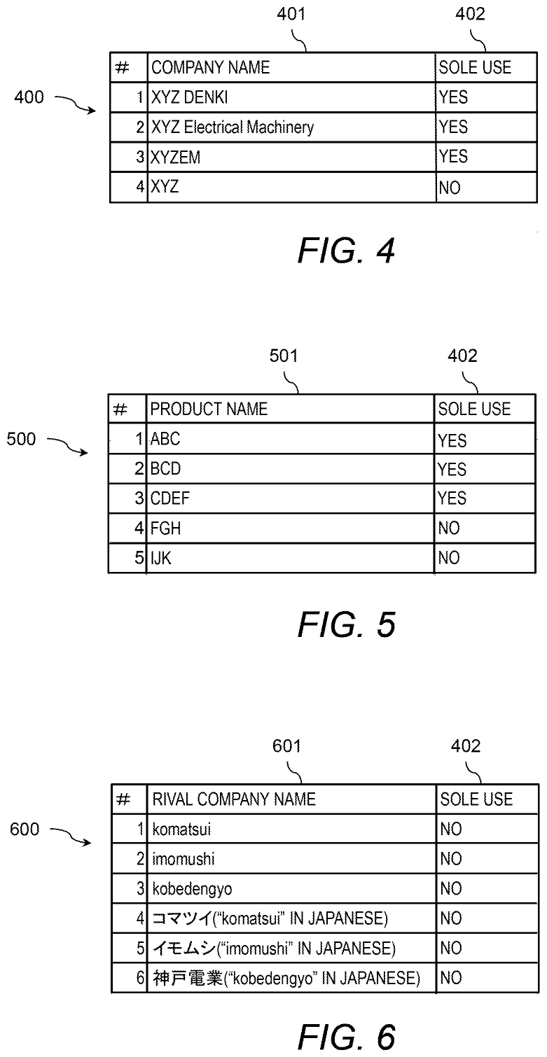

FIGS. 4 to 6 are descriptive drawings 1 to 3 showing examples of search keyword lists 312. FIG. 4 shows a search keyword list 400 in which the type of search keyword is a company name 401. FIG. 5 shows a search keyword list 500 in which the type of search keyword is a product name 501. FIG. 6 shows a search keyword list 600 in which the type of search keyword is a rival company name 601.

All of the search keyword lists 400 to 600 have a sole use condition 402. The sole use condition 402 is a flag that indicates whether the corresponding search keyword can be used on its own. “Yes” indicates that the corresponding search keyword can be used on its own. In entry number 1 of the search keyword list 400, for example, the company name 401 is “XYZ Electrical Machinery” and the sole use condition 402 is set to “yes”. Thus, “XYZ Electrical Machinery” can be used on its own as a search keyword.

“No” indicates that the corresponding search keyword cannot be used on its own. In entry number 4 of the search keyword list 400, for example, the company name 401 is “XYZ” and the sole use condition 402 is set to “no”. Thus, “XYZ” cannot be used on its own as a search keyword. A search keyword with a sole use condition 402 of “no” can be used in combination with other search keywords for a search by the search unit 301. Other search keywords may be present in the same search keyword list or may be present in other search keyword lists. Also, the sole use condition 402 of other search keywords may be “yes” or “no”.

The search keyword lists 400 to 600 are set in the detection apparatus 100 in advance or by the user operating the user device 101. The search keyword is selected by the detection apparatus 100 in consideration of the sole use condition 402 of the search keyword lists 400 to 600.

The company name 401 is a name of the company. The company name 401 may be in Japanese or in another language (such as English). The company name 401 may be an abbreviation. The product name 501 is the representative name or model number of a product by the company that manufactures the product. A nickname having an equivalent brand value may be used for the product name 501. The rival company name 601 is another company in the same industry as the company specified under the company name 401. By performing a search thereof in combination with the company name 401, it is possible to search for applications that handle products or parts by various manufacturers in the industry.

Returning to FIG. 3, the search result count upper limit 313 is a value that determines the upper limit of search results that can be acquired by the detection apparatus 100 among the group of URLs searched from the distribution server 102. If, for example, the search result count upper limit 313 is “50”, then the detection apparatus 100 acquires, from a group of URLs subject to the search, the top 50 URLs by score in the distribution server 102. In this case, the detection apparatus 100 removes all URLs from the 51st down.

The search result count upper limit 313 is set in the detection apparatus 100 in advance or by the user operating the user device 101.

The access sleep interval 314 is a time interval for which the search process is set to sleep from when the detection apparatus 100 accesses the distribution server 102 to execute the search process using the search keyword to when the detection apparatus 100 accesses the distribution server 102 next. Setting the access sleep interval 314 mitigates a situation in which the distribution server 102 blocks access from the detection apparatus 100 as a result of too many accesses from the detection apparatus 100 to the distribution server 102 in a short period of time.

The access sleep interval 314 is set in the detection apparatus 100 in advance or by the user operating the user device 101.

The whitelist 331 is a list of information that stores application IDs of legitimate applications. The application ID is unique identification information for identifying applications, and the application ID differs for different applications. The application IDs of legitimate applications are recorded in the whitelist 331 of the detection apparatus 100 and the distribution server 102. The application IDs of the whitelist 331 are set in advance or by the user operating the user device 101.

The exclusion list 332 is a list of information that stores application IDs of applications to be excluded. Applications to be excluded are applications that are not legitimate applications but should not be included in the search results from the distribution server 102, or in other words, applications that have already been detected as illegitimate applications, for example. The application IDs of applications to be excluded are recorded in the whitelist 331 of the detection apparatus 100 and the distribution server 102. The application IDs of the exclusion list 332 are set in advance or by the user operating the user device 101.

The evaluation condition database 360 has an evaluation keyword list 361 and scoring rules 362. The evaluation keyword list 361 is a list of information pertaining to evaluation keywords. There is an evaluation keyword list 361 for each type of evaluation keyword. The evaluation keyword is for evaluating whether an application of which the specification page was searched is an illegitimate application.

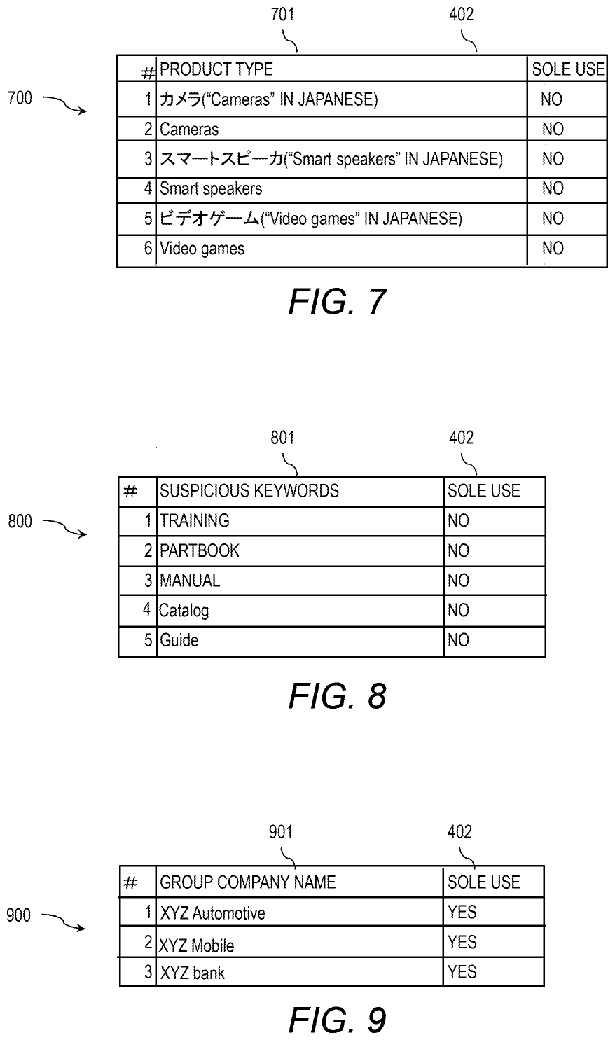

FIGS. 7 to 9 are descriptive drawings 1 to 3 showing examples of evaluation keyword lists 361. FIG. 7 shows an evaluation keyword list 700 in which the type of evaluation keyword is a product type name 701. FIG. 8 shows an evaluation keyword list 800 of suspicious keywords 801 in which the type of evaluation keyword is suspicious. FIG. 9 shows an evaluation keyword list 900 in which the type of evaluation keyword is a group company name 901.

All of the evaluation keyword lists 700 to 900 have the above-mentioned sole use condition 402. The sole use condition 402 is a flag that indicates whether the corresponding evaluation keyword can be used on its own. “Yes” indicates that the corresponding evaluation keyword can be used on its own. In entry number 1 of the evaluation keyword list 900, for example, the group company name 901 is “XYZ Automotive” and the sole use condition 402 is set to “yes”. Thus, “XYZ Automotive” can be used on its own as an evaluation keyword.

“No” indicates that the corresponding evaluation keyword cannot be used on its own. In entry number 2 of the evaluation keyword list 700, for example, the product type name 701 is “Cameras” and the sole use condition 402 is set to “no”. Thus, “Cameras” cannot be used on its own as an evaluation keyword. An evaluation keyword with a sole use condition 402 of “no” can be used in combination with other evaluation keywords for evaluation by the evaluation unit 305. The other evaluation keywords may be present in the same evaluation keyword list or may be present in other evaluation keyword lists. Also, the sole use condition 402 of the other evaluation keywords may be “yes” or “no”.

The evaluation keyword lists 700 to 900 are set in the detection apparatus 100 in advance or by the user operating the user device 101. The evaluation keyword is selected by the detection apparatus 100 in consideration of the sole use condition 402 of the evaluation keyword lists 700 to 900. The detection apparatus 100 may use at least one of the search keyword lists 400 to 600 as the evaluation keyword list 361.

The product type name 701 is a name of the type of product handled by the company. Applications that do not have hits with only the company name 401 might have hits when the company name is searched in combination with the product type name 701.

The suspicious keyword 801 is a given keyword that a user believes to be in common use in specification pages 132 of illegitimate applications, or has actually been used before in specification pages 132 of illegitimate applications. Specifically, the suspicious keyword 801 is a general word that is commonly included in documents created by companies, for example. More specifically, the suspicious keyword 801 is a keyword that pertains to the usage method for an application such as a user manual, a catalog, or a training book, a keyword that pertains to the usage method for a product connected to the application, or a keyword pertaining to a description of a part or the like that constitutes the product.

If the company name 401 and the product name 501 are searched in combination, electronic application versions of documents sometimes receive hits. If the suspicious keyword 801 is used in the specification page 132 of an illegitimate application, the end user might mistake the illegitimate application for a legitimate application and download the illegitimate application onto the end user terminal 103. In order to prevent such downloads of illegitimate applications, the suspicious keyword 801 is set as the search condition.

The group company name 901 is another company name in the same group as the company specified under the company name 401. In some cases, applications provided by a group company or applications of a partner company that engages in business with the group company receive hits.

Returning to FIG. 3, the scoring rules 362 are information that defines a score item for evaluating illegitimate application candidates in an illegitimate application candidate detection list (specification page data) 350, and points corresponding to the presence or lack of a score entry. The illegitimate application candidate detection list (specification page data) 350 is character string information including, for each illegitimate application candidate, an application name, description, and in-image text of the illegitimate application candidate.

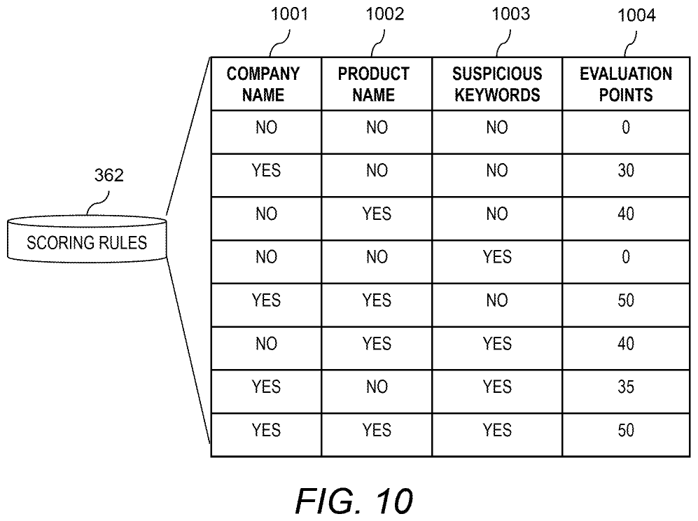

FIG. 10 is a descriptive view showing an example of the scoring rules 362. The scoring rules 362 have a first evaluation item 1001 (corresponding to the company name 401), a second evaluation item 1002 (corresponding to the product name 501), a third evaluation item 1003 (corresponding to the suspicious keyword 801), and evaluation points 1004 corresponding to the first to third evaluation items 1001 to 1003. In this example of the scoring rules 362, the search keyword list 400 and the search keyword list 500 are used as evaluation keyword lists, and the evaluation keyword list 800, among the evaluation keyword lists 700 to 900, is used. In FIG. 9, there are three evaluation items, but there may be one, two, or four or more evaluation items.

The evaluation points 1004 are points determined according to eight possible combinations of yes/no for the first to third evaluation items 1001 to 1003 in the illegitimate application candidate detection list (specification page data) 350. The higher the evaluation points 1004 are, the higher the probability is that the application is an illegitimate application.

Returning to FIG. 3, the search unit 301 accesses the distribution server 102 having the group of specification pages pertaining to the transaction item (in this example, an application) using a search keyword pertaining to a legitimate transaction item, thereby searching the distribution server 102 for a given specification page including a character string that matches or relates to the search keyword. Here, the character string pertaining to the search keyword is a character string including the search keyword such as a word that is a forward match, a backward match, or a partial match to the search keyword. Also, the search unit 301 may search for a character string that includes a portion of the search keyword as a character string pertaining to the search keyword. Additionally, if the search keyword is a combination of a plurality of search keywords, a character string that includes some search keywords among the plurality of search keywords may be searched as a character string pertaining to the search keyword.

Below, a detailed description will be made regarding the search unit 301. The search unit 301 has an extraction unit 302 and a search refinement unit 303. The extraction unit 302 searches for specification pages in the distribution server 102 according to search conditions of the search condition database 310, and extracts the URLs of the specification pages of illegitimate application candidates as search results. Search conditions of the search condition database 310 include a country code selected from the country designation list 311, a search keyword selected from the search keyword list 312, the search result count upper limit 313, and the access sleep interval 314.

Specifically, the extraction unit 302 transmits search information including the URL of the distribution server 102, the search keyword, and the country code to the distribution server 102, for example. The distribution server 102 searches for a group of specification pages according to search conditions, and returns to the extraction unit 302 the URLs of the specification pages of the corresponding illegitimate application candidates (including application IDs of the illegitimate application candidates) as search results. The search results are a list of information in which URLs to corresponding specification pages are listed in the order of a score based on the degree of coincidence to the search keywords in the distribution server 102.

The extraction unit 302 extracts, from the search results, URLs starting with the URL with the top score to the URL matching the search result count upper limit 313 in sequential order, and outputs the URLs as an illegitimate application candidate detection URL list 320. The extraction unit 302 stops transmission of search information to the distribution server 102 during the access sleep interval 314, and every time the access sleep interval 314 elapses, the extraction unit 302 generates search information with a different search keyword and transmits the search information to the distribution server 102.

The search refinement unit 303 uses at least one of the whitelist 331 or the exclusion list 332 to narrow down URLs in the illegitimate application candidate detection URL list 320. Specifically, if the search refinement unit 303 uses the whitelist 331, for example, it deletes URLs including application IDs in the whitelist 331 from the illegitimate application candidate detection URL list 320.

Also, if the search refinement unit 303 uses the exclusion list 332, for example, it deletes URLs including application IDs in the exclusion list 332 from the illegitimate application candidate detection URL list 320. The illegitimate application candidate detection URL list 320 outputted from the search refinement unit 303 is referred to as the illegitimate application candidate detection URL list (unnecessary data deleted) 340. The search refinement unit 303 is not a necessary function but rather one that can be selected. If the search refinement unit 303 is not used, the illegitimate application candidate detection URL list 320 outputted from the extraction unit 302 is outputted to the acquisition unit 304.

The acquisition unit 304 accesses the distribution server 102 with reference to the illegitimate application candidate detection URL list (unnecessary data deleted) 340 from the search unit 301 or the illegitimate application candidate URLs in the illegitimate application candidate detection URL list 320, and acquires from the distribution server 102 specification page data of specification pages corresponding to the illegitimate application candidate detection URLs. In the case of the specification page 132 shown in FIG. 1, for example, the specification page data includes text data extracted from the icon 141, the application name 142, the provider name 143, text data of the download button 144, text data extracted from the thumbnail image 145, and the description 146.

The specification page data of each acquired specification page is referred to as the illegitimate application candidate detection list (specification page data) 350. The text data extracted from the icon 141 and the text data extracted from the thumbnail image 145 are referred to as in-image text.

The evaluation unit 305 uses the evaluation condition database 360 to evaluate the specification page data in the illegitimate application candidate detection list (specification page data) 350. Specifically, the evaluation unit 305 searches for the specification page data in the illegitimate application candidate detection list (specification page data) 350 using an evaluation keyword in the evaluation keyword list 361, for example.

The evaluation unit 305 determines whether or not the evaluation keyword is present for each piece of specification page data in the illegitimate application candidate detection list (specification page data) 350, and calculates evaluation points using the scoring rules 362. Specifically, the evaluation unit 305 calculates, using the scoring rules 362, evaluation points regarding whether or not the evaluation keyword is present in the application name 142 of the specification page data in the illegitimate application candidate detection list (specification page data) 350, and whether or not the evaluation keyword is present in the the description 146 and the in-image text.

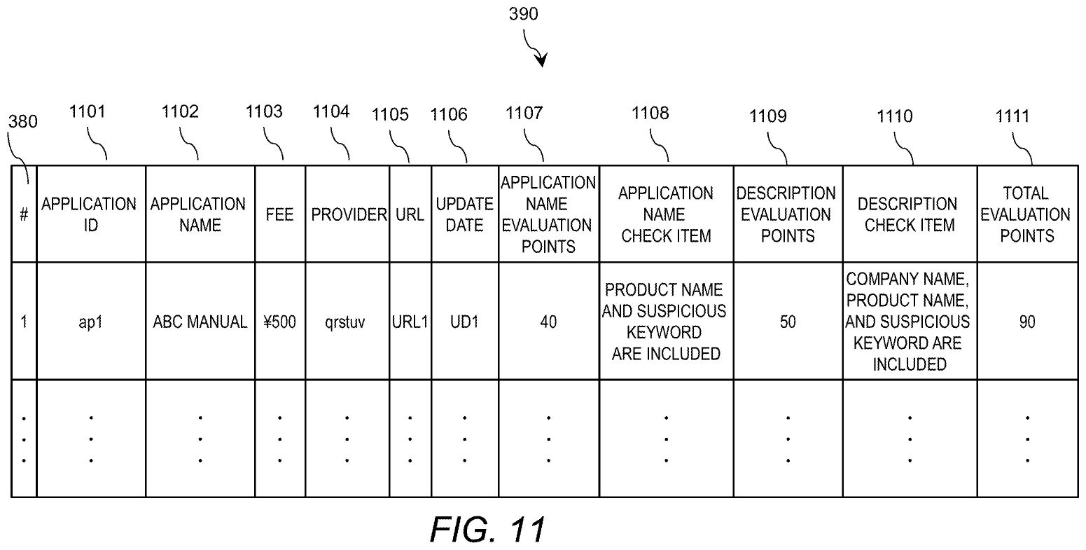

The evaluation unit 305 calculates total points by adding up the evaluation points. The higher the total points are, the higher the probability is that the specification page is of an illegitimate application. Thereafter, the evaluation unit 305 outputs the illegitimate application candidate detection list (with scores) 370. The illegitimate application candidate detection list (with scores) 370 is specification page data (see FIG. 11) that includes, for each specification page in the illegitimate application candidate detection list (specification page data) 350, an application ID 1101, an application name 1102, a fee 1103, a provider 1104, a URL 1105, an update date 1106, application name evaluation points 1107, an application name check item 1108, description evaluation points 1109, a description check item 1110, and total evaluation points 1111.

The creation unit 306 creates an illegitimate application candidate detection list 390 by adding the illegitimate application candidate detection list (with scores) 370 to an illegitimate application candidate detection list template 380.

FIG. 11 is a descriptive drawing showing an example of an illegitimate application candidate detection list 390. The illegitimate application candidate detection list 390 includes an application ID 1101, an application name 1102, a fee 1103, a provider 1104, a URL 1105, an update date 1106, application name evaluation points 1107, an application name check item 1108, description evaluation points 1109, a description check item 1110, total evaluation points 1111. These fields constitute the illegitimate application candidate detection list template 380 and the entry in each item number is specification page data of the illegitimate application candidate.

The application ID 1101 is included in the URL 1105 of the specification page in the illegitimate application candidate detection list (specification page data) 350. The application name 1102 is a character string indicating the application name 142 in the specification page in the illegitimate application candidate detection list (specification page data) 350.

The fee 1103 is a character string indicating the price in the specification page in the illegitimate application candidate detection list (specification page data) 350. In the case of the specification page 131 of FIG. 1, the download button 144 says “Install”, and thus, the price is 0 yen, whereas in the case of the specification page 132 of FIG. 1, the download button 144 says “¥500”, and thus, the price is 500 yen.

The provider 1104 is a character string indicating the provider name 143 in the specification page in the illegitimate application candidate detection list (specification page data) 350. The URL 1105 is a URL that can access the specification page in the illegitimate application candidate detection list (specification page data) 350. The update date 1106 is the latest date on which the specification page in the illegitimate application candidate detection list (specification page data) 350 was updated.

The application name evaluation points 1107 are evaluation points calculated by the evaluation unit 305. Specifically, the application name evaluation points 1107 are evaluation points 1004 attained when the scoring rules 362 are applied in determining the presence or absence of the evaluation keyword in the application name 142, for example.

The application name check item 1108 is a combination of values of the first to third evaluation items 1001 to 1003 that serves as the source for calculating the application name evaluation points 1107. The application name check item 1108 in the first entry, for example, states “a product name and a suspicious keyword are included”, because, regarding the presence or absence of an evaluation keyword in the application name 142, the value for the first evaluation item 1001 is “no”, the value for the second evaluation item 1002 is “yes”, and the value for the third evaluation item 1003 is “yes”.

The description evaluation points 1109 are evaluation points calculated by the evaluation unit 305. Specifically, the description evaluation points 1109 are evaluation points 1004 attained when the scoring rules 362 are applied in determining the presence or absence of the evaluation keyword in the description 146, for example. Also, the description evaluation points 1109 may be evaluation points 1004 attained when the scoring rules 362 are applied in determining the presence or absence of the evaluation keyword in the description 146 and in the in-image text. The in-image text is a character string attained by recognizing a character string pattern included in the icon 141 or the thumbnail image 145 by an image recognition process and converting the character string pattern into text.

A character string “ABC” is recognized from the icon 141 in the specification page 131 of FIG. 1, and a character string “XYZEM” is recognized from the icon 141 of the specification page 132. Character strings saying “edit” and “save” are recognized from the thumbnail image 145 of the specification page 131, and character strings “ABC” and “manual” are recognized from the thumbnail image 145 of the specification page 132.

The description check item 1110 is a combination of values of the first to third evaluation items 1001 to 1003 that serves as the source for calculating the description evaluation points 1109. The description check item 1110 in the first entry, for example, states “a company name, a product name, and a suspicious keyword are included”, because, regarding the presence or absence of an evaluation keyword in the description 146, the value for the first evaluation item 1001 is “yes”, the value for the second evaluation item 1002 is “yes”, and the value for the third evaluation item 1003 is “yes”.

The total evaluation points 1111 are the total of the application name evaluation points 1107 and the description evaluation points 1109 calculated by the evaluation unit 305 for the specification pages in the illegitimate application candidate detection list (specification page data) 350.

Returning to FIG. 3, the output unit 307 outputs the illegitimate application candidate detection list 390 created by the creation unit 306 to the user device 101. Specifically, for example, the output unit 307 transmits the illegitimate application candidate detection list 390 through the network 104 to the designated user device 101. The output unit 307 may print out the illegitimate application candidate detection list 390 or transmit the same to a printer on the network 104. Also, the output unit 307 may store the illegitimate application candidate detection list 390 in the storage device 202 in the detection apparatus 100 or store the same in storage on the network 104.

<Setting Screen Example>

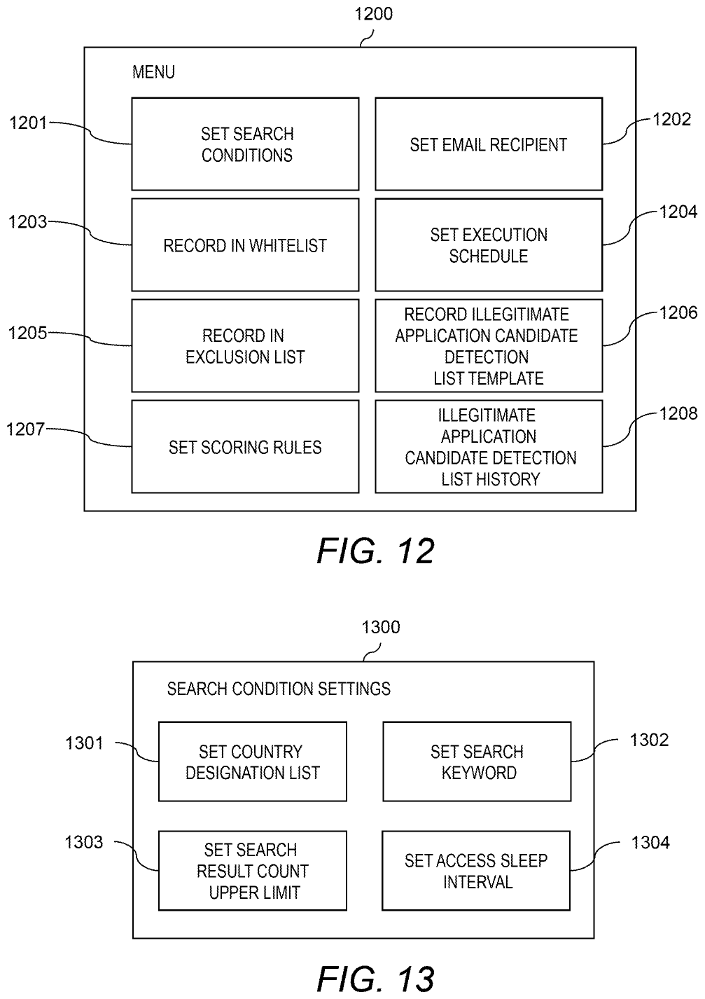

Next, an example of setting various information in advance using the detection apparatus 100 will be described with reference to FIGS. 12 to 17. The screens of FIGS. 12 to 17 are displayed in a display, which is an example of the output device 204 of the detection apparatus 100.

FIG. 12 is a descriptive view showing an example of a menu screen. A menu screen 1200 has a search condition setting button 1201, an email recipient setting button 1202, a whitelist recording button 1203, an execution schedule setting button 1204, an exclusion list recording button 1205, an illegitimate application candidate detection list template recording button 1206, a scoring rule setting button 1207, and an illegitimate application candidate detection list history button 1208.

The search condition setting button 1201 is a button for setting the content of the search condition database 310 by user operation. When the search condition setting button 1201 is pressed, a search condition setting screen 1300 shown in FIG. 13 is displayed.

The email recipient setting button 1202 is a button for setting the recipient of an email, that is, the email address by user operation. When the email recipient setting button 1202 is pressed, a setting screen for setting the email recipient (not shown) is displayed. When the email address is set by being inputted to the setting screen by user operation, the output unit 307 transmits the illegitimate application candidate detection list 390 to the recorded email address. In the example of FIG. 3, the user device 101 in which the menu screen 1200 is displayed and the user device 101 that is the recipient of the email are set as the same user device 101.

The whitelist recording button 1203 is a button for recording the application ID in the whitelist 331 by user operation. When the whitelist recording button 1203 is pressed, a recording screen for recording the application ID (not shown) is displayed. When the application ID is recorded by being inputted to the recording screen by user operation, the search refinement unit 303 narrows down the illegitimate application candidate detection URL list 320 using the whitelist 331 after the application ID is recorded therein.

The execution schedule setting button 1204 is a button for setting the execution schedule by user operation. The execution schedule is a schedule by which the detection apparatus 100 generates the illegitimate application candidate detection list 390. Specifically, the execution schedule is a periodic execution start time such as 9:00 every Monday, for example. The execution schedule may be set for each search condition such as country or search keyword. When the execution schedule setting button 1204 is pressed, a setting screen for setting the execution schedule (not shown) is displayed. When the execution schedule is recorded by being inputted to the setting screen by user operation, the detection apparatus 100 starts execution according to the set execution schedule.

The exclusion list recording button 1205 is a button for recording the application ID in the exclusion list 332 by user operation. When the exclusion list recording button 1205 is pressed, a recording screen for recording the application ID (not shown) is displayed. When the application ID is recorded by being inputted to the recording screen by user operation, the search refinement unit 303 narrows down the illegitimate application candidate detection URL list 320 using the exclusion list 332 after the application ID is recorded therein.

The illegitimate application candidate detection list template recording button 1206 is a button for recording the illegitimate application candidate detection list template by user operation. When the illegitimate application candidate detection list template recording button 1206 is pressed, a recording screen for recording the illegitimate application candidate detection list template 380 (not shown) is displayed. When the illegitimate application candidate detection list template 380 is recorded by being inputted to the recording screen by user operation, the creation unit 306 creates the illegitimate application candidate detection list 390 using the illegitimate application candidate detection list template 380.

The scoring rule setting button 1207 is a button for setting the scoring rules 362 by user operation. When the scoring rule setting button 1207 is pressed, a setting screen for setting the scoring rules 362 (not shown) is displayed. When the scoring rules 362 are set by being inputted to the setting screen by user operation, the evaluation unit 305 evaluates the specification page data in the illegitimate application candidate detection list (specification page data) 350 using the set scoring rules 362.

The illegitimate application candidate detection list history button 1208 is a button for displaying the history of the illegitimate application candidate detection list 390. When the illegitimate application candidate detection list history button 1208 is pressed, past illegitimate application candidate detection lists 390 are displayed in the display of the detection apparatus 100.

FIG. 13 is a descriptive view showing an example of the search condition setting screen. The search condition setting screen 1300 is called by the search condition setting button 1201 being pressed. The search condition setting screen 1300 has a country designation list setting button 1301, a search keyword setting button 1302, a search result count upper limit setting button 1303, and an access sleep interval setting button 1304.

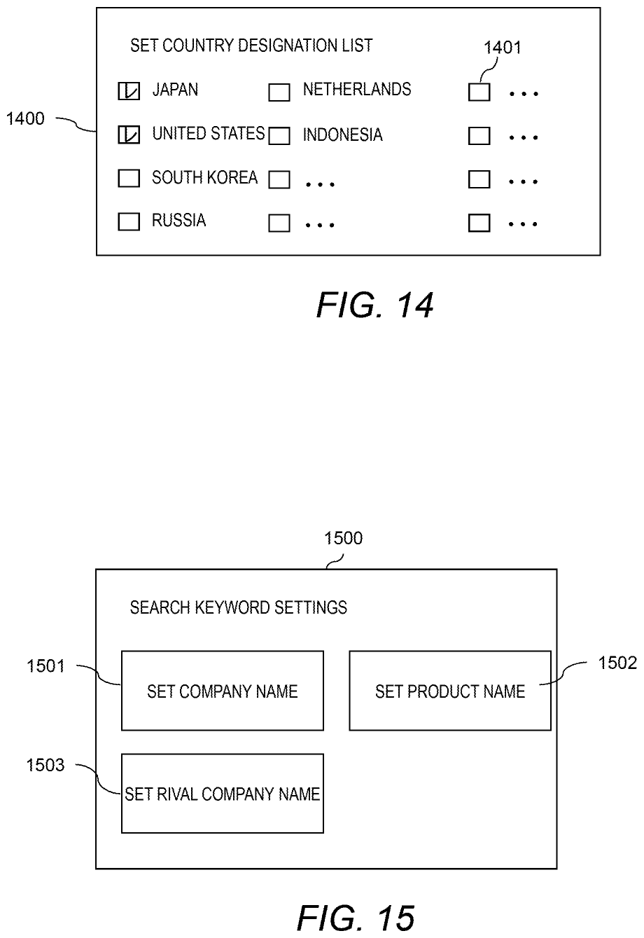

The country designation list setting button 1301 is a button for setting the designation of the country for which the search by the search keyword is to be performed by user operation. When the country designation list setting button 1301 is pressed, a country designation list setting screen 1400 shown in FIG. 14 is displayed.

The search keyword setting button 1302 is a button for setting the search keyword by user operation. When the search keyword setting button 1302 is pressed, a search keyword setting screen 1500 shown in FIG. 15 is displayed.

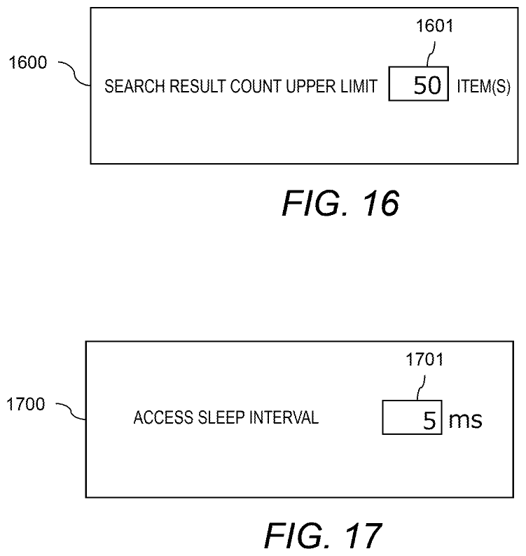

The search result count upper limit setting button 1303 is a button for setting the search result count upper limit 313 by user operation. When the search result count upper limit setting button 1303 is pressed, a search result count upper limit setting screen 1600 shown in FIG. 16 is displayed.

The access sleep interval setting button 1304 is a button for setting the access sleep interval 314 by user operation. When the access sleep interval setting button 1304 is pressed, an access sleep interval setting screen 1700 shown in FIG. 17 is displayed.

FIG. 14 is a descriptive view showing an example of the country designation list setting screen 1400. The country designation list setting screen 1400 is called by the country designation list setting button 1301 being pressed. The country designation list setting screen 1400 has a checkbox 1401 for each country. In FIG. 14, the checkboxes 1401 for Japan and the United States are checked. When the checkboxes 1401 are checked by user operation, the detection apparatus 100 transmits to the distribution server 102 search information including the country codes of the countries that are checked when accessing the distribution server 102.

FIG. 15 is a descriptive view showing an example of the search keyword setting screen. The search keyword setting screen 1500 is called by the search keyword setting button 1302 being pressed. The search keyword setting screen 1500 has a company name setting button 1501, a product name setting button 1502, and a rival company name setting button 1503. The company name setting button 1501 is a button that calls a company name setting screen (not shown). The company name is recorded in the search keyword list 312 by being inputted to the company name setting screen by user operation.

The product name setting button 1502 is a button that calls a product name setting screen (not shown). The product name is recorded in the search keyword list 312 by being inputted to the product name setting screen by user operation. The rival company name setting button 1503 is a button that calls a rival company name setting screen (not shown). The rival company name is recorded in the search keyword list 312 by being inputted to the rival company name setting screen by user operation.

FIG. 16 is a descriptive view showing an example of the search result count upper limit setting screen 1600. The search result count upper limit setting screen 1600 is called by the search result count upper limit setting button 1303 being pressed. The search result count upper limit setting setting screen 1600 has an input field 1601 for inputting the search result count upper limit 313. In FIG. 16, “50” is inputted in the input field 1601 as the search result count upper limit 313. When the search result count upper limit 313 is inputted by user operation into the input field 1601, the detection apparatus 100 extracts, from the search results, URLs starting with the URL with the top score in the distribution server 102 to the URL matching the search result count upper limit 313 in sequential order, and outputs the URLs as an illegitimate application candidate detection URL list 320.

FIG. 17 is a descriptive view showing an example of the access sleep interval setting screen 1700. The access sleep interval setting screen 1700 is called by access sleep interval setting button 1304 being pressed. The access sleep interval setting display screen 1700 has an input field 1701 for setting the access sleep interval 314. In FIG. 17, “5” is inputted in the input field 1701 as the access sleep interval 314. When the access sleep interval 314 is inputted by user operation into the input field 1701, then when the detection apparatus 100 executes a search process using a search keyword in the distribution server 102, the detection apparatus 100 puts the search process in a sleep state from when it is currently accessing the distribution server 102 to when it subsequently accesses the same. Setting the access sleep interval 314 mitigates a situation in which the distribution server 102 blocks access from the detection apparatus 100 as a result of too many accesses from the detection apparatus 100 to the distribution server 102 in a short period of time.

<Example of Illegitimate Application Detection Process Method Performed by Detection Apparatus 100>

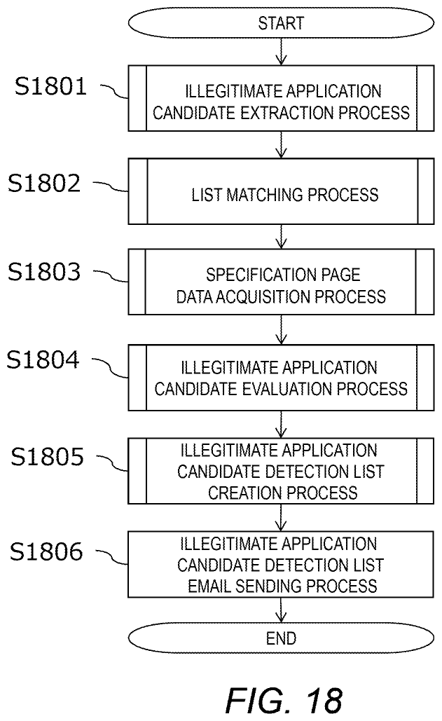

FIG. 18 is a flowchart showing an example of steps for the detection apparatus 100 to perform the illegitimate application detection process. The detection apparatus 100 executes an illegitimate application candidate extraction process performed by the extraction unit 302 (step S1801), a list comparison process performed by the search refinement unit 303 (step S1802), a specification page data acquisition process performed by the acquisition unit 304 (step S1803), an illegitimate application candidate evaluation process performed by the evaluation unit 305 (step S1804), an illegitimate application candidate detection list creation process performed by the creation unit 306 (step S1805), and an illegitimate application candidate detection list email sending process performed by the output unit 307 (step S1806). The illegitimate application candidate detection list email sending process (step S1806) is performed by the output unit 307 sending the illegitimate application candidate detection list created by the creation unit 306 to the email address of the recipient set through the email recipient setting button 1202.

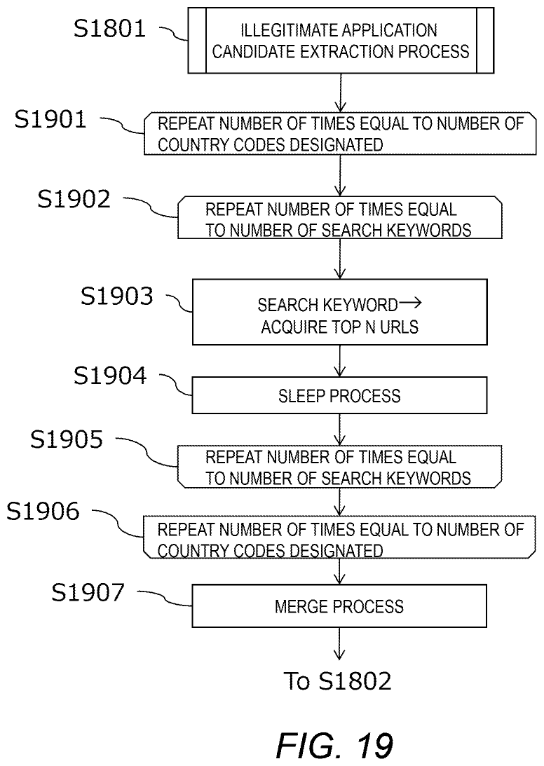

FIG. 19 is a flow chart showing an example of detailed process steps of the illegitimate application candidate extraction process (step S1801) performed by the extraction unit 302. If there are country codes within the group of country codes that have not yet been selected in the country designation list setting screen 1400 of FIG. 14, then the extraction unit 302 selects one country code that has not yet been selected (step S1901) and executes steps S1902 to S1905 on the selected country code. If there are country codes that have not yet been selected, then the process returns to step S1901 and if there are no country codes that have not been selected (step S1906), then the process progresses to step S1807.

The extraction unit 302 selects the selected country code if there are search keywords that have not yet been selected in the search keyword list 312 (step S1902), and executes steps S1903 and S1904 for the selected search keyword. If there are search keywords that have not yet been selected, then the process returns to step S1902 and if there are no search keywords that have not been selected (step S1905), then the process returns to step S1901 and the extraction unit 302 selects one country code that has not yet been selected.

Here, in step S1902, the search keyword selected on its own from the search keyword lists 400 to 600 of FIGS. 4 to 6 is a search keyword for which the sole use condition 402 is “yes”. Search keywords for which the sole use condition 402 is “no” are selected in combination with one or more other search keywords that have a sole use condition 402 of “yes” or “no”.

For example, the search keyword “XYZ” for the company name 401 of FIG. 4 can be selected in combination with one or more other search keywords in the search keyword lists 500 and 600. However, if a search keyword where the sole use condition 402 is “no” is included within the other search keyword, the search keyword may be excluded from being combined. For example, the search keyword “XYZ” for the company name 401 in FIG. 4 is included in the search keywords “XYZ DENKI”, “XYZ Electrical Machinery”, and “XYZEM” for the company name 401 of the search keyword list 400, and thus, these may be excluded from being combined. As a result, it is possible to execute the illegitimate application candidate extraction process (step S1801) in a comprehensive and efficient manner.

In step S1903, the extraction unit 302 accesses the distribution server 102 with search information including the selected country code and the selected search keyword, searches the group of specification pages in the distribution server 102, and acquires the top N (N=search result count upper limit 313) URLs among the group of URLs to the searched specification pages (step S1903).

In step S1904, the extraction unit 302 executes the sleep process for a time equal to the access sleep interval 314 (step S1904). As a result, access to the distribution server 102 is blocked. Then, the extraction unit 302 returns to step S1902 if there are search keywords that have not yet been selected, and if there are no search keywords that have not been selected (step S1905), the extraction unit 302 progresses to step S1906.

In step S1907, the extraction unit 302 generates the illegitimate application candidate detection URL list 320 by executing the merge process (step S1907), and progresses to the list comparison process (step S1802). If a URL to the specification page of a given application can be used in multiple countries, then a separate search would be performed for each country code. As a countermeasure, the extraction unit 302 executes a merge process in which only one instance among a plurality of instances of the same URL that were acquired for each of the country codes is left remaining, with the other instances being deleted. As a result, the illegitimate application candidate detection URL list 320 does not have a plurality of instances of the same URL. Therefore, a redundant process of searching the same URL a plurality of times is eliminated from following processes, and thus, it is possible to increase the efficiency of the illegitimate application detection process.

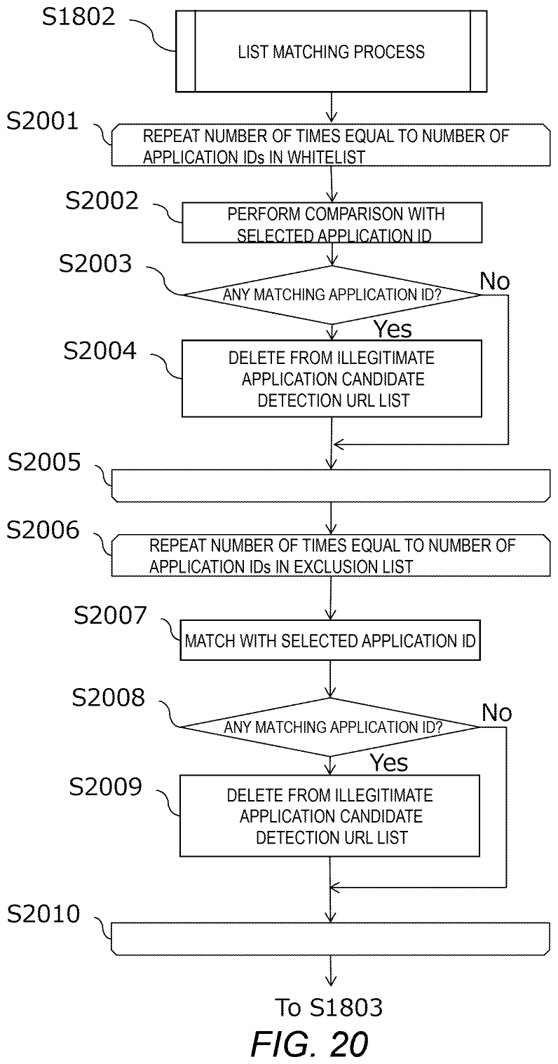

FIG. 20 is a flow chart showing an example of detailed process steps of the list comparison process (step S1802) performed by the search refinement unit 303. The search refinement unit 303 selects one application ID if there are application IDs that have not yet been selected in the whitelist list 331 (step S2001), and executes steps S2002 to S2004. If there are application IDs that have not yet been selected, then the process returns to step S2001 and if there are no application IDs that have not been selected (step S2005), then the process progresses to step S2006.

The search refinement unit 303 compares the selected application ID to the illegitimate application candidate detection URL list 320 (step S2002), and determines whether or not there are URLs including the application ID that match the selected application ID (step S2003). If there are no URLs including application IDs that match the selected application ID (step S2003: no), then the process progresses to step S2005. If there is a URL including an application ID that matches the selected application ID (step S2003: yes), then the search refinement unit 303 deletes the URL including the application ID matching the selected application ID from the illegitimate application candidate detection URL list 320 (step S2004) and the process progresses to step S2005.

The search refinement unit 303 selects one application ID if there are application IDs that have not yet been selected in the exclusion list 332 (step S2006), and executes steps S2007 to S2009. If there are application IDs that have not yet been selected, then the process returns to step S2006 and if there are no application IDs that have not been selected (step S2010), then the process progresses to the specification page data acquisition process (step S1803).

The search refinement unit 303 compares the selected application ID to the illegitimate application candidate detection URL list 320 (step S2007), and determines whether or not there are URLs including the application ID that match the selected application ID (step S2008). If there are no URLs including application IDs that match the selected application ID (step S2008: no), then the process progresses to step S2010. If there is a URL including an application ID that matches the selected application ID (step S2008: yes), then the search refinement unit 303 deletes the URL including the application ID matching the selected application ID from the illegitimate application candidate detection URL list 320 and outputs the illegitimate application candidate detection URL list (unnecessary data deleted) 340 (step S2009) and the process progresses to step S2005.

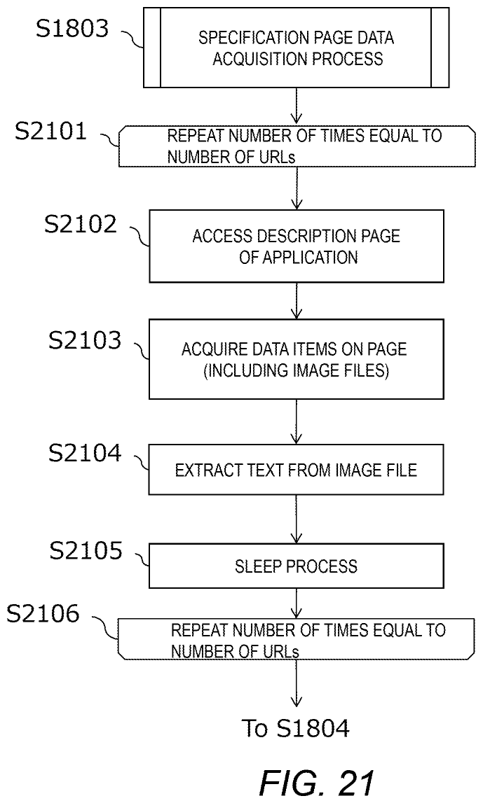

FIG. 21 is a flow chart showing an example of detailed process steps of the specification page data acquisition process (step S1803) performed by the acquisition unit 304. The acquisition unit 304 selects a URL that has not yet been selected from the illegitimate application candidate detection URL list (unnecessary data deleted) 340 (step S2101), executes steps S2102 to S2105, and then progresses to step S2106. If there are URLs that have not yet been selected, then the acquisition unit 304 progresses to step S2101 and if there are no URLs that have not been selected, then the acquisition unit 304 progresses to the illegitimate application candidate evaluation process (step S1804).

The acquisition unit 304 accesses the distribution server 102 with the selected URL and acquires the specification page therefrom (step S2102). As shown in FIG. 1, for example, the acquisition unit 304 acquires the specification page 132. The acquisition unit 304 acquires data items from the specification page that was acquired (step S2103). In the case of the specification page 132 shown in FIG. 1, for example, the data items include the icon 141, the application name 142, the provider name 143, the download button 144, the thumbnail image 145, and the description 146.

The acquisition unit 304 extracts text data from the image file (step S2104). In the case of the specification page 132 shown in FIG. 1, for example, text data is extracted by image recognition from the icon 141, the download button 144, and the thumbnail image 145. The acquisition unit 304 executes the sleep process for a time equal to the access sleep interval 314 (step S2105). As a result, access to the distribution server 102 is blocked. Then, if there are URLs that have not been selected, then the acquisition unit 304 returns to step S2101 and if there are no URLs that have not been selected, then the acquisition unit 304 outputs the illegitimate application candidate detection list (specification page data) 350 (step S2106) and progresses to the illegitimate application candidate evaluation process (step S1804).

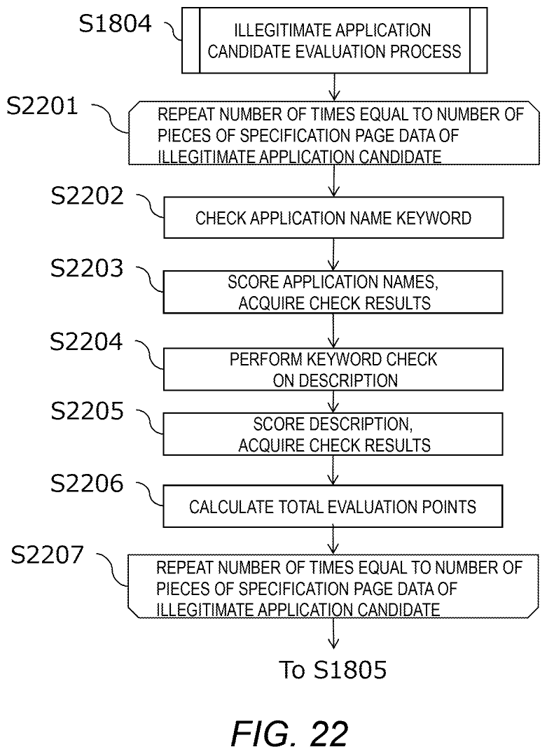

FIG. 22 is a flow chart showing an example of detailed process steps of the illegitimate application candidate evaluation process (step S1804). The evaluation unit 305 selects one piece of specification page data of the illegitimate application candidate that has not yet been selected from the illegitimate application candidate detection list (specification page data) 350 (step S2201), executes steps S2202 to S2206 for the selected specification page data, and then progresses to step S2207.

In step S2202, the evaluation unit 305 determines whether or not the application name in the selected specification page data corresponds to an evaluation keyword in the evaluation keyword list 361 (step S2202). Here, in step S2202, the evaluation keyword to be compared on its own is an evaluation keyword for which the sole use condition 402 is “yes”. Evaluation keywords for which the sole use condition 402 is “no” are compared in combination with one or more other evaluation keywords that have a sole use condition 402 of “yes” or “no”. This similarly applies to steps S2204 and S2206.

In step S2203, the evaluation unit 305 applies the determination results from step S2202 to the first to third evaluation items 1001 to 1003 of the scoring rules 362, calculates the evaluation points 1004 of the application name 142 as the application name evaluation points 1107, acquires the check results for the first to third evaluation items 1001 to 1003 as the application name check item 1108, and adds the application name evaluation points 1107 and the application name check item 1108 to the selected specification page data (step S2203).

In step S2204, the evaluation unit 305 determines whether or not the description 146 and the in-image text in the selected specification page data correspond to an evaluation keyword in the evaluation keyword list 361 (step S2204).

In step S2205, the evaluation unit 305 applies the determination results from step S2204 to the first to third evaluation items 1001 to 1003 of the scoring rules 362, calculates the evaluation points 1004 of the description 146 and the in-image text as the description evaluation points 1109, acquires the check results for the first to third evaluation items 1001 to 1003 as the description check item 1110, and adds the description evaluation points 1109 and the description check item 1110 to the selected specification page data (step S2205).

In step S2205, the evaluation unit 305 totals the evaluation points 1004 of the application name and the evaluation points 1004 of the description and the in-image text, calculates the total evaluation points, and adds the total evaluation points to the selected specification page data (step S2205).

Then, if there is specification page data of an illegitimate application candidate that has not yet been selected, then the evaluation unit 305 returns to step S2201 and if there is specification page data of an illegitimate application candidate that has not yet been selected, then the evaluation unit 305 outputs the illegitimate application candidate detection list (with scores) 370 (step S2207) and progresses to the illegitimate application candidate detection list creation process (step S1805).

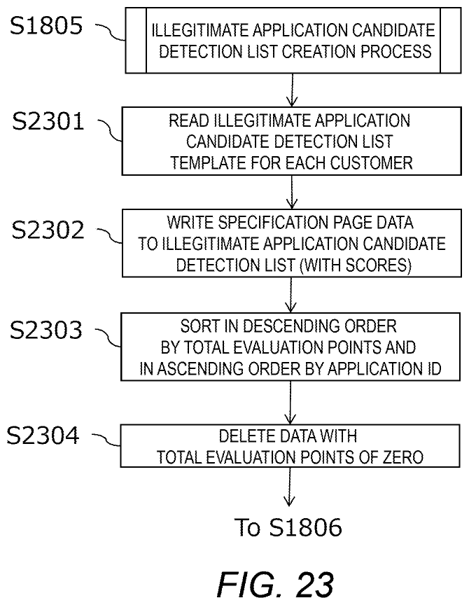

FIG. 23 is a flow chart showing an example of detailed process steps of the illegitimate application candidate detection list creation process (step S1805) performed by the creation unit 306. The creation unit 306 reads the illegitimate application candidate detection list template 380 (step S2301). The creation unit 306 writes specification page data of the illegitimate application candidate detection list (with scores) 370 to the illegitimate application candidate detection list template 380 that was read in (step S2302).

The creation unit 306 sorts the group of written specification page data in descending order by total evaluation points 1111 and ascending order by application ID 1101 (step S2302). As a result, a plurality of pieces of specification page data with the same total evaluation points 1111 are sorted in ascending order by application ID 1101.

The creation unit 306 deletes specification page data in which the total evaluation points 1111 amount to 0 (step S2304). The total evaluation points 1111 of the specification page data to be deleted is not limited to 0, and may be set to a prescribed number of points or less that is greater than 0. Then, the process progresses to the illegitimate application candidate detection list email sending process (step S1806).

(1) Thus, the detection apparatus 100 of the present embodiment has the processor 201 that is configured to executes programs, and a storage device 202 that stores the programs. The processor 201 is configured to execute: a search process in which, as a result of accessing the distribution server 102 having a group of specification pages that pertain to an application using a search keyword pertaining to a legitimate application, given specification pages including a character string that matches or is related to the search keyword are searched from the distribution server 102; an acquisition process of acquiring, from the given specification pages found by the search process, a first evaluation character string (application name 142, for example) that identifies given applications included in the given specification pages, and a second evaluation character string (description 146, for example) that describes the given applications; an evaluation process of evaluating whether or not the given specification pages are specification pages pertaining to an illegitimate application on the basis of evaluation keywords relating to illegitimate applications and the first and second evaluation character strings acquired in the acquisition process; and an output process of outputting the evaluation results from the evaluation process. As a result, it is possible to detect illegitimate application candidates automatically.

(2) In the detection apparatus 100 from (1), during the search process, the processor 201 accesses the distribution server 102 using a search keyword and a country code, thereby searching, in the distribution server 102, for a given specification page that includes a character string that matches or is related to the search keyword and for which the country is designated. As a result, it is possible to detect illegitimate application candidates that are only provided in a given country.

(3) In the detection apparatus 100 from (1), during the search process, the processor 201 removes specification pages including character strings matching or related to the search keyword from the given specification pages on the basis of a given application ID. As a result, it is possible exclude legitimate applications or applications that have already been detected as illegitimate applications.

(4) In the detection apparatus from (1), during the search process, the processor 1 accesses the distribution server 102 using the search keyword, and after a prescribed period of time has elapsed, accesses the distribution server 102 with another search keyword. As a result, a case in which the distribution server 102 blocks access from the detection apparatus 100 as a result of too many accesses from the detection apparatus 100 to the distribution server 102 in a short period of time is mitigated.

(5) In the detection apparatus from (1), during the acquisition process, the processor 201 accesses a given page, and after a prescribed period of time has elapsed, accesses another given page. As a result, a case in which the distribution server 102 blocks access from the detection apparatus 100 as a result of too many accesses from the detection apparatus 100 to the distribution server 102 in a short period of time is mitigated.

(6) In the detection apparatus 100 from (1), during the acquisition process, the processor 201 acquires, from the given specification page, a third evaluation character string identified from an image included in the given specification page. As a result, it is possible to detect illegitimate application candidates with character strings acquired from images.

(7) In the detection apparatus 100 from (1), during the evaluation process, the processor 201 evaluates whether a given specification page is a specification page pertaining to an illegitimate application on the basis of a first evaluation for determining whether the evaluation keyword is included in a first evaluation character string (application name 142, for example) and a second evaluation for determining whether the evaluation keyword is included in a second evaluation character string (description 146, for example). As a result, it is possible to evaluate a given specification page from different evaluation perspectives in the given specification page.

(8) In the detection apparatus 100 from (1), the evaluation keyword includes the same keyword as the search keyword and a keyword differing from the search keyword. As a result, the evaluation keyword and the search keyword partially overlap, and thus, it is possible to search, as a specification page of an illegitimate application candidate, a specification page that includes a search keyword included in the specification page of a legitimate application and an evaluation keyword that is not included in the specification page of a legitimate application. That is, it is possible to detect illegitimate application candidates that are similar to but not the same as legitimate applications.

(9) In the detection apparatus 100 from (1), the search keyword is at least one of the company name 401, the product name 501, or the rival company name 601 of the application, and the evaluation keyword is at least one of the company name 401, the product name 501, or the suspicious keyword 801 of the application. In this manner, if the search keyword and the evaluation keyword partially overlap, it is possible to search, as a specification page of an illegitimate application candidate, a specification page that includes a search keyword included in the specification page of a legitimate application and a suspicious keyword that is not included in the specification page of a legitimate application.

(10) In the detection apparatus 100 from (9), the suspicious keyword 801 is a keyword pertaining to the usage method for the application, the usage method for a product linked to the application, or a description of components of the application. As a result, it is possible to suitably evaluate the specification page of illegitimate application candidates.

It should be noted that this invention is not limited to the above-mentioned embodiments, and encompasses various modification examples and the equivalent configurations within the scope of the appended claims without departing from the gist of this invention. For example, the above-mentioned embodiments are described in detail for a better understanding of this invention, and this invention is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

1. A detection apparatus, comprising:
a processor that is configured to execute a program; and
a storage device that stores the program,
wherein the processor is configured to execute:
a search process of accessing a site having a group of pages pertaining to transaction items using a search keyword pertaining to a legitimate transaction item, thereby searching the site for a given page including a character string that matches or relates to the search keyword;
an acquisition process of acquiring, from the given page found by the search process, a first evaluation character string that indicates a given transaction item that is included in the given page, and a second evaluation character string that describes the given transaction item;
an evaluation process of evaluating whether the given page is a page pertaining to an illegitimate transaction item on the basis of an evaluation keyword pertaining to an illegitimate transaction item, and the first and second evaluation character strings acquired by the acquisition process; and
an output process of outputting evaluation results obtained by the evaluation process.

2. The detection apparatus according to claim 1,
wherein, in the search process, the processor accesses the site using the search keyword and a code indicating a country, thereby searching the site for a given page that includes the character string that matches or relates to the search keyword and in which the country is designated.

3. The detection apparatus according to claim 1,
wherein, in the search process, the processor removes a page including the character strings matching or related to the search keyword from the given pages on the basis of identification information that uniquely identifies the given transaction item.

4. The detection apparatus according to claim 1,
wherein, in the search process, the processor accesses the site using the search keyword, and after a prescribed period of time has elapsed, accesses the site using another search keyword.

5. The detection apparatus according to claim 1,
wherein, in the acquisition process, the processor accesses the given page, and after a prescribed period of time has elapsed, accesses another of the given page.

6. The detection apparatus according to claim 1,
wherein, in the acquisition process, the processor acquires, from the given page, a third evaluation character string identified from an image included in the given page.

7. The detection apparatus according to claim 1,
wherein, in the evaluation process, the processor evaluates whether the given page is a page pertaining to an illegitimate transaction item on the basis of a first evaluation for determining whether the evaluation keyword is included in the first evaluation character string and a second evaluation for determining whether the evaluation keyword is included in the second evaluation character string.

8. The detection apparatus according to claim 1,
wherein the evaluation keyword includes a same keyword as the search keyword and a keyword differing from the search keyword.

9. The detection apparatus according to claim 1,
wherein the search keyword includes at least one of a name of a provider of the transaction item, a name of the transaction item, and a name of a rival to the provider of the transaction item, and
wherein the evaluation keyword includes at least one of the name of the provider of the transaction item, the name of the transaction item, and given keyword pertaining to a feature of the transaction item.

10. The detection apparatus according to claim 9,
wherein the given keyword includes a usage method for the transaction item, a usage method for another transaction item linked to the transaction item, or a keyword pertaining to a description of a component of the transaction item.

11. A detection method executed by a detection apparatus including a processor that is configured to execute a program, and a storage device that stores the program,
wherein the processor is configured to execute:
a search process of accessing a site having a group of pages pertaining to transaction items using a search keyword pertaining to a legitimate transaction item, thereby searching the site for a given page including a character string that matches or relates to the search keyword;
an acquisition process of acquiring, from the given page found by the search process, a first evaluation character string that indicates a given transaction item that is included in the given page, and a second evaluation character string that describes the given transaction item;
an evaluation process of evaluating whether the given page is a page pertaining to an illegitimate transaction item on the basis of an evaluation keyword pertaining to an illegitimate transaction item, and the first and second evaluation character strings acquired by the acquisition process; and
an output process of outputting evaluation results obtained by the evaluation process.

12. A non-transitory recording medium having stored thereon a detection program that causes a processor to execute:
a search process of accessing a site having a group of pages pertaining to transaction items using a search keyword pertaining to a legitimate transaction item, thereby searching the site for a given page including a character string that matches or relates to the search keyword;
an acquisition process of acquiring, from the given page found by the search process, a first evaluation character string that indicates a given transaction item that is included in the given page, and a second evaluation character string that describes the given transaction item;
an evaluation process of evaluating whether the given page is a page pertaining to an illegitimate transaction item on the basis of an evaluation keyword pertaining to an illegitimate transaction item, and the first and second evaluation character strings acquired by the acquisition process; and
an output process of outputting evaluation results obtained by the evaluation process.
